(19) United States
(12) Patent Application Publication
(10) Pub. No.: US 2023/0065856 A1
(43) Pub. Date: Mar. 2, 2023

(54) MODULAR MALTING PLANT

(71) Applicant: BÜHLER GMBH, Beilngries (DE)

(72) Inventor: Johannes KOLB, Ingolstadt (DE)

(73) Assignee: BÜHLER GMBH, Beilngries (DE)

(21) Appl. No.: 17/799,356

(22) PCT Filed: Feb. 12, 2021
(86) PCT No.: PCT/EP2021/053514

§ 371 Date: Aug. 12, 2022

(30) Foreign Application Priority Data
Feb. 13, 2020 (EP) 20157261.7

(51) Int. Cl. C12C 1/033; C12C 1/10

(52) U.S. Cl. CPC C12C 1/033; C12C 1/10

(57) ABSTRACT

A malting plant for germinating and kiln-drying grain, having a heating unit with a heating device and at least one expandable germinating/kiln-drying unit. The plant includes a starting module having an air channel; at least one intermediate module; and an end module. The starting module is connected a connector channel and a return channel to the heating unit. The malting plant is configured to selectively conduct air from outside of the starting module into the process chamber(formed by the starting module, intermediate module and end module) and/or circulate air from the process chamber via the air channel into the process chamber using the germinating fan during the germinating process of the grain, and conduct air that has been temperature-controlled by the heating device in the heating unit via the connector channel into the process chamber via the starting module during the kiln-drying process of the grain.

The present disclosure relates to a malting plant for germinating and kiln-drying grain. A malting plant can also comprise a device for steeping. In particular, the disclosure relates to a modularly constructed malting plant which allows the product batch (the production volume per batch) to be adjusted in a stepwise manner, specifically to be increased.

Malting plants are used to produce malt, the higher-value raw material, from the raw material of cereal. The malt is then further used to make products such as beer, distillates, or in the food industry, for example.

In the malting of grain for the production of beer or whiskey, for example, grain is normally first steeped while water is added and is then germinated under controlled temperature and moisture conditions and, in the process, turned at regular intervals. To stop the germination process and render the malt stable, it is then dried using a supply of hot air. This process is also called kiln-drying. For this purpose, plants of different sizes are provided depending on the production volume.

In order for it to be possible to start the malting process, water is added to the cereal (barley, wheat, rye, etc.) in order to overcome dormancy, so that the grain begins to sprout due to water absorption. The maltster calls this first of a total of three process steps during malting “steeping.”

Steeping begins with a wet phase in a cylindroconical stainless steel container, which is called a steep tank. In this container, the grain is immersed at a water temperature of 15-20° C. and kept in motion with forced aeration. If the product is not circulated during the wet steep, the grain could die due to lack of oxygen. After approximately three to five hours, the water is drained and the first dry steep begins. This occurs through aeration in the form of a removal of the accumulating carbon dioxide by suction via a radial fan. The dry phase lasts for around ten hours, and another, shorter wet phase follows and then another dry phase. Once the grain has reached a moisture content of approximately 44 percent (after approximately 24 hours, depending on the cereal), the second malting step, germinating, begins.

Germinating is carried out on a kiln floor, onto which the grain is transferred following the steeping process. It stays there for about four to six days, depending on the cereal, cultivar, year, and growing region. With constant cooling and aeration using humidified air at approximately 15-20° C. via a radial fan, the grain can continue to grow. During germination, the skeletal material that retains the starch cells is broken down and the grain is thus opened up. Enzymes that can convert starch into sugar also form during germination. Once the grain has been sufficiently opened up, the growth process must be stopped by means of drying in the third and final process step, kiln-drying.

Kiln-drying is initiated by an increase in the air volume flow and a temperature increase to approximately 50-65° C. for approximately 14 hours. The cereal is then dry and should develop a color and aroma using even higher temperatures at approximately 80-85° C. After approximately six hours, the kiln-drying process is stopped by fresh air cooling, and the malting is thus finished. These basic malting processes are described, for example, in the publications by Narziss, L.: Malz [Malt]. In: Heiss, R. (ed.): Lebensmitteltechnologie: Biotechnologische, chemische, mechanischc and thermische Verfahren der Lebensmittelverarbeitung [Food Technology: Biotechnological, Chemical, Mechanical, and Thermal Methods of Food Processing], Springer Berlin Heidelberg, 2013, and by Narziss, L.: Vom Rohstoff bis zur kalten Wdrze—Entwicklungen der letzten 25 Jahre, Mitteilungsblatt Deutscher Braumeister-und Malzmeister-Bund [From the Raw Material to the Cold Wort—Developments of the Last 25 Years, Newsletter of the German Master Brewers and Master Maltsters Association], Issue 2, May 2018.

WO2013/044984A1 describes a device and method for steeping, germinating, fermenting, and/or combinations thereof, grain, wherein the device comprises a container with at least one plate which can be mounted in the container and which has at least one opening for the supply and/or removal of fluid. EP2336458A1 discloses a round container, in particular a germination box or a kiln in a malthouse, and a method for the production thereof. Malting plants are also known from the documents DE1206835B, U.S. Pat. No. 2,500,775A, CN208562299U, and DE2656365A1.

Small-scale malting plants differ from industrial malting plants on the basis of the design for smaller annual capacity. A capacity limit for the classification of small-scale malting plants lies in the range of approximately 1-50 t/batch.

Small-scale malting plants for testing and educational purposes have capacities of<1 t/batch.

There are three malting systems: one chamber systems, two chamber systems, three chamber systems.

A one chamber system is to be understood as meaning that the three process steps of steeping, germinating, and kiln-drying are carried out in one device. With Central European barley, that is a total of 7 days (1 day of steeping, 5 days of germinating, and 1 day of kiln-drying). At 365 process days in a year. a maximum of 52 batches can thus be produced (365 days/7 days/batch).

The cereal remains in the same device during the malting process. Since all three process steps (steeping, germinating, kiln-drying) are carried out in one device, it is only possible to produce one batch. The shape of one chamber systems can include both rectangular boxes and also cylindrical tanks. Both have a kiln floor through which the cereal is supplied with process air during the malting.

In two chamber systems, steeping and germinating/kiln-drying are carried out in different chambers. The peripheral equipment for the process step of steeping is thus independent of the process steps of germinating and kiln-drying, which are carried out in a separate, shared device.

However, the steeped cereal must be transported into the germinating/kiln-drying device from the steeping device. At 365 process days in a year, approximately 61 batches can thus be produced (365 days/6 days/batch). This is possible since, during the changeover from germinating to kiln-drying, steeping can once again take place simultaneously in the steeping device, and no additional day is therefore lost for steeping. Kiln-drying and steeping can occur in parallel.

In two chamber systems, the steeping is carried out in a cylindroconical tank and then transferred into the combined germinating/kiln-drying device. This germinating/kiln-drying device can be composed of a drum that rotates to turn the product during germination, or of a rectangular box that is equipped with a turning machine. A round box with a turning machine is also possible.

In the three chamber system, steeping, germinating, and kiln-drying are separate and also independent of one another in terms of peripheral equipment. At 365 process days in a year, approximately 73 batches can thus be produced (365 days/5 days/batch). Because after the germinating device has been unloaded into the kiln-drying device, the former can already be refilled with steeped material from the steep tank. Steeping, germinating, and kiln-drying can thus occur in parallel.

The three chamber system is composed of a cylindroconical steep tank and of either rectangular germination boxes and a rectangular kiln, or of rectangular germination boxes and a round kiln or round germination boxes and a round kiln.

Particularly for small malthouses, for example for the production of specialty malts for the craft beer industry, the investment costs for building a plant can be too high or the sizing can be chosen incorrectly as a result of increasing demand.

The possibility of expanding the malting plant by one or more plant components without having to make large investments in peripheral equipment when doing so represents an added value in economic and environmental terms. The malting plant should be designed for a 24-hour batch rhythm.

The present invention offers a modularly constructed (purposefully expandable) and compact malting plant. the product batch, that is, the production volume per batch, of which can be adjusted in a stepwise manner and individually, in particular increased or decreased. This is achieved with the features below. In particular, the invention is defined by the independent claims; the dependent claims describe embodiments of the invention.

The invention in particular comprises a malting plant for germinating and kiln-drying grain using a heating unit in which a heating device, heat recovery, and a central kiln-drying fan can be installed, and at least one geminating/kiln-drying unit comprising a starting module (base module) with an integrated air channel connected to a germinating fan, at least one intermediate module, and an end module (final module). A steeping unit can be connected upstream. The intermediate module(s) between the starting and end modules form a process or treatment chamber for germinating and kiln-drying grain. The capacity level of the malting plant can be adjusted by changing the size of the process chamber. In particular, at least one additional intermediate module can be inserted between the starting module and the end module. The starting module, the at least two intermediate modules, and the end module are then connected to one another (in a purposefully detachable manner), with the intermediate modules forming the process chamber. By inserting the at least one additional intermediate module, the capacity level of the malting plant can be adjusted and, in particular, expanded.

The starting module is connected (in a purposefully detachable manner) to the heating unit. During the germinating process, the germinating fan in or connected to the starting module selectively introduces fresh air from outside into the process chamber and/or return air from the process chamber back into the process chamber. The air can thereby be guided over a cooling coil in order to cool the process air.

During the kiln-drying process, temperature-controlled air is guided, in particular via a central kiln-drying fan, from the heating unit to the germinating/kiln-drying unit(s) via a fresh air channel and returned back to the heating unit via a return air channel. The aeration normally takes place via two separate fans, namely the germinating fan, which in particular is arranged in the starting module, and the kiln-drying fan in the heating unit. However, the airflows can also be generated by a single fan. Furthermore, the process chamber is formed by the intermediate modules. According to one embodiment of the invention, the starting module and/or end module can also constitute part of the process chamber or treatment chamber.

Additional embodiments preferably comprise the features below. Between the starting module and end module, at least two intermediate modules can be inserted.

The at least two intermediate modules, which can be connected to the starting module and the end module, then form the process chamber, in which the product being malted is located (during the germinating and kiln-drying).

An air channel integrated inside of the starting module and having a germinating fan introduces fresh air and/or return air into the process chamber below the kiln floor of the intermediate modules during the germinating process. On the pressure side of the germinating fan, a cooling coil can be installed which is fed from a cooling system (installed outside of the germinating/kiln-drying unit).

During the kiln-drying process, the central kiln-drying fan of the heating unit introduces temperature-controlled air from the gas burner and/or heating coil (hot water or gas) into the process chamber below the kiln floor in the intermediate modules. In addition to the heater, at least one cross-flow heat exchanger can also be integrated in the heating unit.

At least one starting module can be connected to the heating unit by means of connector channels.

A capacity level of germinated and kiln-dried grain for the malting plant with a heating device can be adjustable from 16 t/batch and day to 56 t/batch and day using the number of process modules. The capacity level (t/day) of germinated and kiln-dried grain per germinating/kiln-drying box can span 16 t to 56 t, preferably 16 t, 24 t, 32 t, 40 t, 48 t and/or 56 t. The malting plant can comprise up to 7 germinating/kiln-drying units per heating unit.

Each germinating/kiln-drying unit preferably comprises a turning device and/or an unloading station. The unloading station is preferably arranged in the starting module.

The process chamber in which the product being malted is located is formed by the intermediate module(s) and preferably has at least two intermediate modules. If need be, the starting and/or end modules can also be part of the process chamber. The process chamber is preferably rectangular and can increase the batch sizes in a stepwise manner through the insertion of additional intermediate modules.

The intermediate modules have a width and a length, wherein the width of the modules preferably essentially corresponds to the width of the starting and end modules and the length of the process chamber depends on the number of intermediate modules.

The grain that is treated in the process chamber is preferably arranged on an air-permeable kiln floor which divides the process chamber into a lower section and an upper section. The fan is preferably configured to introduce the air through the lower section, to allow the air to flow through the grain, and to allow the air to return to the fan through the upper section. This can be carried out selectively using the starting module in the germinating process and via the air channels to the heating unit in the kiln-drying process.

The malting plant can preferably have a steep tank for steeping the grain. The steep tank can be connected to at least one germinating/kiln-drying unit for transporting the steeped grain into the process chamber, that is, preferably the at least one intermediate module or even the base module and/or the end module. The steep tank is preferably embodied such that it can be enlarged in a stepwise manner.

The heating unit preferably has a central kiln-drying fan for circulating the air that is temperature-controlled in the heating device.

The disclosure furthermore comprises a method for malting grain, in particular using a malting plant as described above. The method can in particular comprise the steeping, which can increase the product batch (production volume per batch) in a stepwise manner through the insertion of intermediate rings; the germinating of the grain in the at least two intermediate modules; and/or the kiln-drying of the grain by heating the air by means of the heating device that is integrated in the heating device and is connected to each of the at least one germinating/kiln-drying units.

The method can be carried out with the use of at least one steeping unit, one germinating/kiln-drying unit, and one heating unit, wherein if only one germinating/kiln-drying unit is used, only either the germinating process or the kiln-drying process can take place. With multiple germinating/kiln-drying units, up to 7 germinating/kiln-drying units, the kiln-drying process can take place in one, while a germinating process is carried out in the other(s).

The disclosure also comprises a method for expanding a malting plant as described above. The method comprises the expansion of a steeping unit 7 through the stepwise insertion of intermediate rings 76 on the existing cylinder, and/or the expansion of an existing germinating/kiln-drying unit 5 by extending the process chamber 6, in particular through the addition of one or more intermediate modules 52, and/or by providing an additional germinating/kiln-drying unit and connecting said additional germinating/kiln-drying unit to the heating unit.

The invention is described in greater detail with the aid of the drawings. Here:

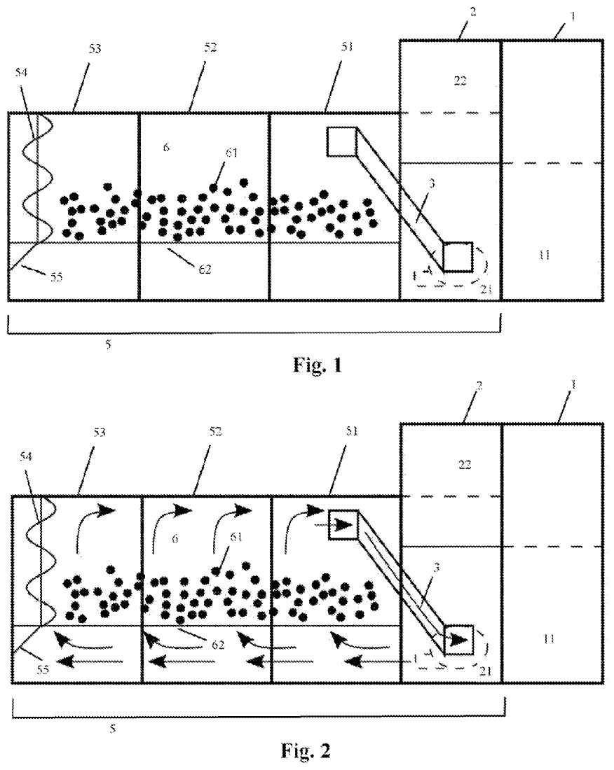

FIG. 1 shows a schematic view of an exemplary embodiment of the invention;

FIG. 2 shows a schematic view of an exemplary embodiment of the invention during germinating operation;

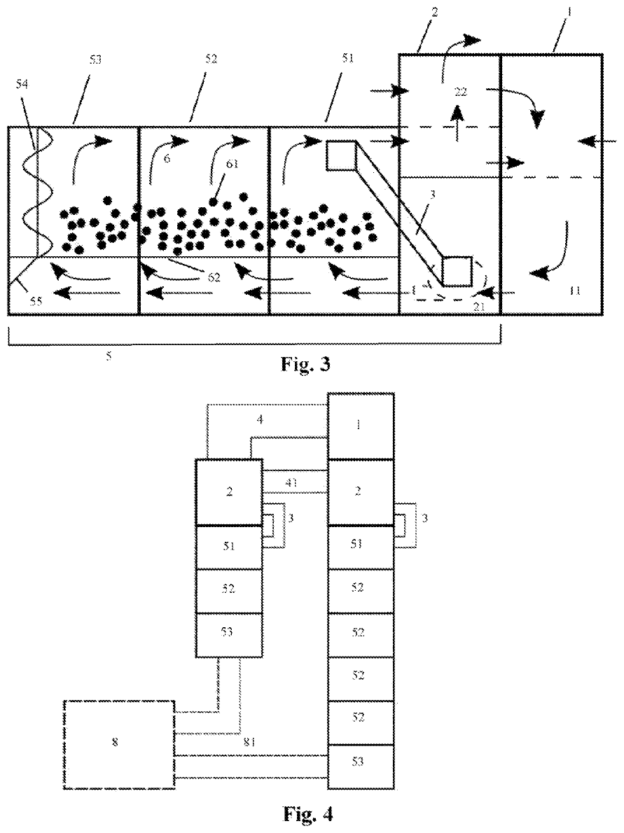

FIG. 3 shows a schematic view of an exemplary embodiment of the invention during kiln-drying operation;

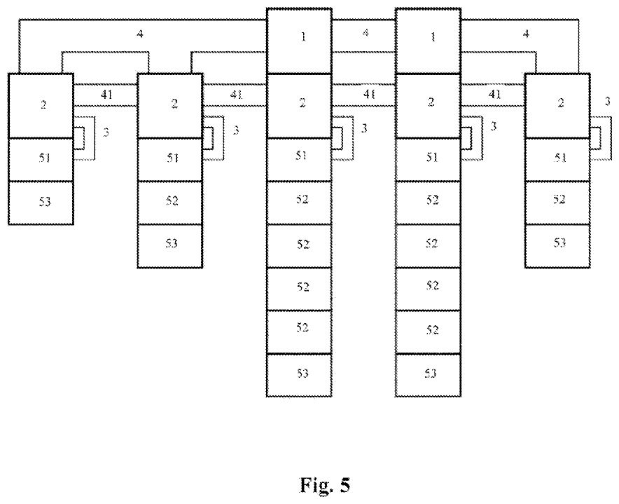

FIG. 4 and show 5 schematic top views of malting plants according to exemplary embodiments of the invention;

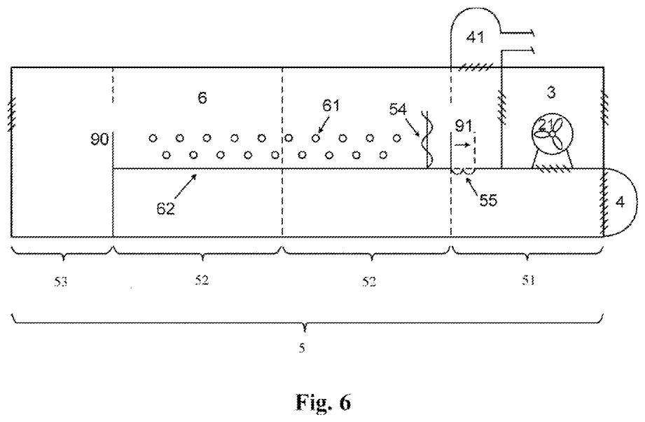

FIG. 6 shows a schematic view of a malting plant according to a preferred embodiment of the present invention;

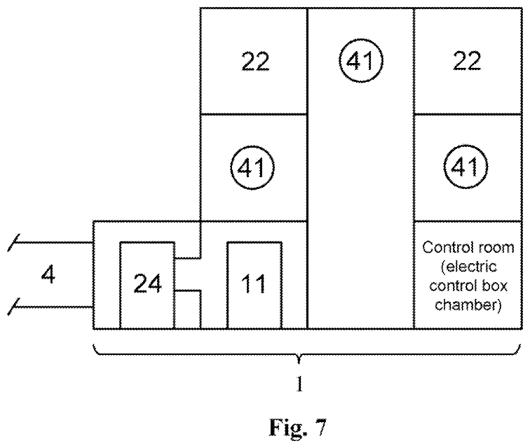

FIG. 7 schematically shows the heating unit of the malting plant according to the preferred embodiment of the invention;

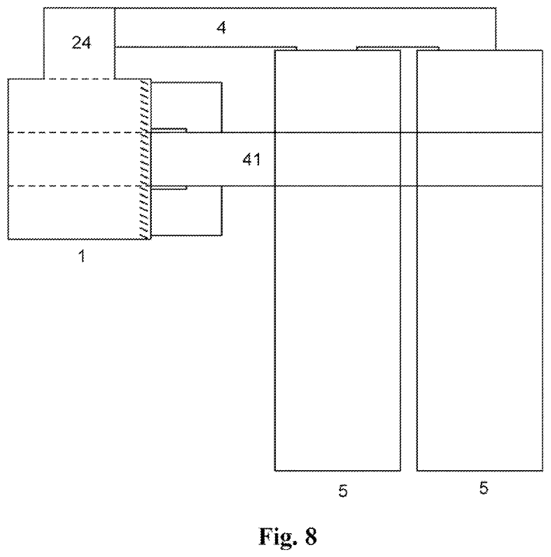

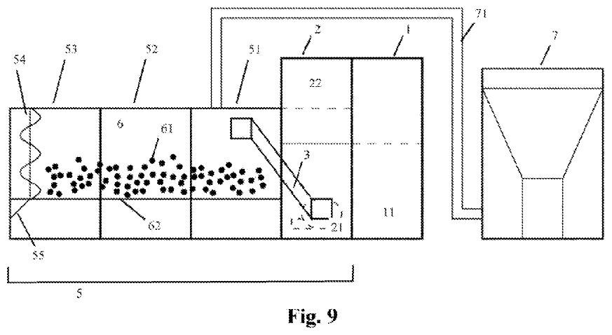

FIG. 8 schematically shows a top view of a malting plant according to the preferred embodiment of the invention;

FIG. 9 shows a schematic view of an exemplary embodiment of the invention with a connected steeping unit;

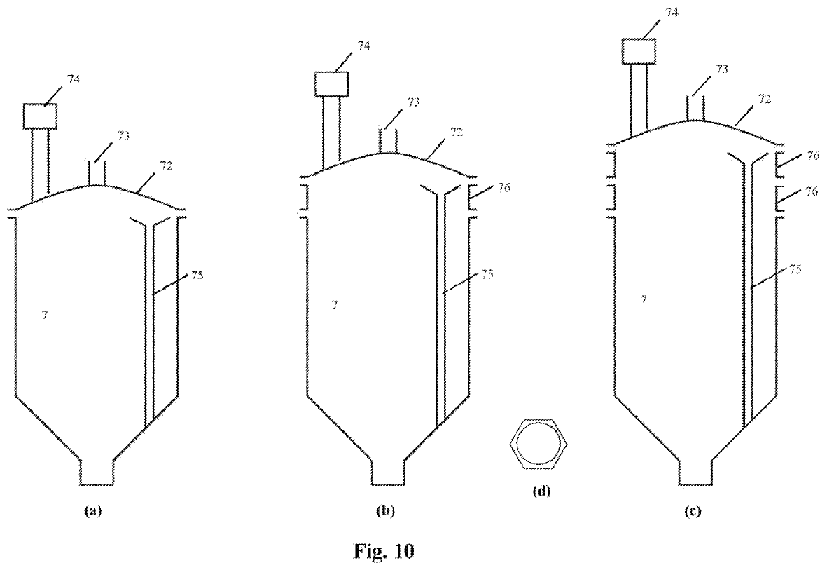

FIG. 10 shows a schematic view of an expandable steeping unit: and

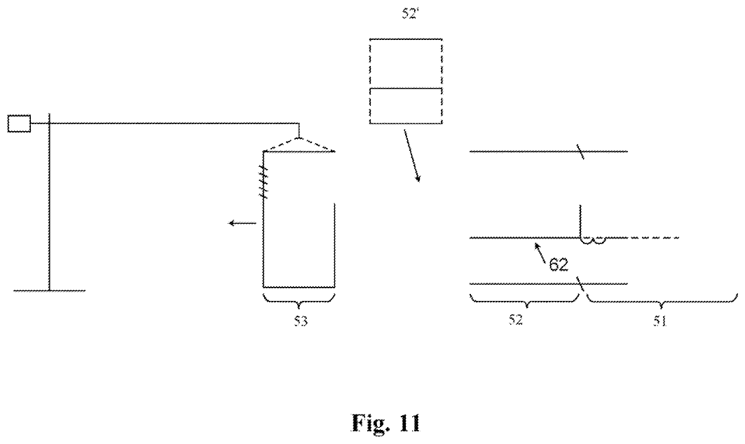

FIG. 11 schematically shows the expansion of the capacity of a germinating/kiln-drying unit.

In order for the malting process to be able to start, water is added to the cereal to overcome dormancy, so that the grain begins to sprout due to water absorption. To ensure a sufficient water absorption, a known steep tank can in particular be used. Here, in order to increase the moisture content in the grain, the grain is steeped in water. The steeping of grain and the corresponding devices are known from the prior art. Alternatively or additionally, a washing screw can also be used. The water absorption can also be carried out in the treatment chamber that is described further below. For the present invention, the grain is preferably wet-steeped and pumped with liquid. The steep tank can thereby be arranged in a separate building and be connected to the malting plant via pipes.

An exemplary malting plant according to the present disclosure is shown in FIG. 1 and comprises a heating building 1, in which a heating device 11 is installed, as well as a process module 5.

Both the heating building 1 and also the process module 5 can be provided in multiple realizations.

The process module 5 can be adapted to the requirements of the respective plant, and accordingly comprises an air building 2 with a fan 21, as well as a germinating/kiln-drying box. The germinating/kiln-drying box is a standardized Saladin box (see for example Bergner, K. G. et al.: Alkoholische Genussmittel [Alcoholic Beverages], Springer Berlin Heidelberg. 2013 (Handbuch der Lebensmittelchemie [Handbook of Food Chemistry]). A Saladin box refers to a stationary kiln floor on which the product lies and on which air flows through the product.

The germinating/kiln-drying box is formed by a base module 51 and a final module 53, and can, if necessary, be expanded by one or more intermediate modules 52 that are inserted between the base module 51 and final module 53. The base module 51, the final module 53, and, where applicable, the intermediate module 52 or intermediate modules 52, are connected to one another and provide in the interiors thereof a treatment chamber 6 in which the germinating and kiln-drying of the grain can be carried out. The base module 51 is furthermore connected to the air building 2.

Preferably, each base module 51, intermediate module 52, and final module 53, hereinafter also referred to as “modules,” has the same dimensions. The modules are preferably embodied to be rectangular. In addition, they can be formed from rust-proof stainless steel or sheet metal parts or steel beams. Each final module 53 is thereby closed on three sides during operation, and can be connected to other modules via the open side. Preferably, an unloading station or hatch 55 is arranged on the side opposite from the open side. The base module 51 is connected to the air building 2 on one side and is open on the opposite side, and can therefore be connected to the other modules. The open side of the base module 51 can be connected either directly to the final module 53 or to the intermediate modules 52 positioned therebetween. Each of the intermediate modules 52 is thus open on two sides so that it can be arranged between the base module 51 and final module 53.

Preferably, the modules have a height of approximately 4.8 m, a width of approximately 4.2 m, and a length of approximately 4.5 m. Maximally, 5 intermediate modules with a length of 4.5 m each can be used, which corresponds to a total length of 7×4.5 m=31.5 m (base module, 5 intermediate modules, and final module). In particular, each of the modules preferably holds a capacity of 5 to 10 t, particularly preferably 8 t. Specific densities of cereal are 45-54 kg/hl for oats, 57-70 kg/h1 for barley, 58-77 kg/hl for rye, and 62-87 kg/hl for wheat. Other dimensions of the modules may also be expedient.

In the air building 2, a heat exchanger 22 and/or a cooling system (not shown) or a cooling coil can be installed. ICS COOL ENERGY, iC530/iC660 can be used as cooling technology for the germination air, for example (https:/www.iescoolenergy.com/app/uploads/Broschuere_I-Chiller_ICSCoolEnergy_2018.pdf). In addition, the malting plant or the process module 5 comprises an air channel 3 which connects the fan 21 or the air building 2 to the germinating/kiln-drying box. Normally, the cooling system is arranged outside of the process module 5, and the cooling coil is arranged in the fan chamber, for example, or even in the air channel 3, or such that it is connected thereto. The air channel 3 is preferably mounted outside of the process module 5. It is particularly preferred if the air channel 3 is mounted outside of and alongside the process module 5.

As a heating device 11 in the heating building 1, a burner, a hot water coil, or a boiler can be used, for example. In addition, other heat sources, such as geothermal energy, heat pumps, or solar systems for example, can be used. An additional heat exchanger 22 can utilize the waste heat of neighboring industrial operations to increase the efficiency, for example. This additional heat exchanger can be situated in the heating building 1 or in connector channels. If a heat exchanger 22 is used, the waste air is mainly used during the wilting process in kiln-drying, in order to heat the fresh air in the cross-flow method. The heat exchanger 22 is thereby preferably arranged such that it is displaced from the heating device 11, that is, not in the heating building 1.

In the germinating/kiln-drying box constructed from the modules 51, 53 and additional module(s) 52, if any, the malt is germinated, and is subsequently dried or kiln-dried. Normally, an air-permeable kiln floor 62 is installed in the box, which kiln floor 62 divides the treatment chamber 6 into an upper and a lower region. The product 61 is preferably arranged in the upper region, and air is introduced into the lower region and can penetrate into the product 61 through the kiln floor 62. In the process, the air can be temperature-controlled depending on the requirements. Preferably, the air channel 3 connects the air building 2 to the base module 51. The upper region of the treatment chamber 6 of the base module 51 is thereby connected to the fan 21 in the air building 2 via the air channel 3, which fan 21 transports the air into the lower region of the treatment chamber 6. In other words, the waste air that has already passed through the product 61 is conducted out of the upper region of the treatment chamber 6 and recirculated into the lower region of the treatment chamber 6 via the fan 21. Depending on the mode of operation, the waste air can be conducted to the fan 21 through the air channel 3 or the heat exchanger 22 and the heating device 11. For this purpose, devices, in particular cut-off dampers, can be used which prevent the supply to the base module 51 from the direction of the heat exchanger 22 or heating building 1 during germination on the one hand and, on the other hand, stop the ingress into the air channel 3. or from the air channel 3 into the fan chamber, during kiln-drying.

The air can thereby be circulated by the fan either in an unmodified manner or such that it is temperature-controlled by means of the cooling system 23 or the heating device 11 in the heating building 1. In addition, a heat exchanger 22 can be arranged in the air building 2 in order to increase the efficiency. This heat exchanger 22 can be embodied in particular as a cross-flow heat exchanger. Thus, both the germinating and also the kiln-drying can be carried out using the same fan 21. In the air building 2, in particular at the fan 21, means (not shown) are preferably provided for selectively conveying the air from the air channel 3 (circulation or cooling operation) or the heating building 1 or heating device 11 (heating operation) or from the ambient environment (outside air) into the treatment chamber 6. In particular, these means can be embodied as louvers or dampers. Other devices may also be expedient. The air channel 3 can furthermore comprise a return air damper, a fresh air damper, a positive pressure louver or the like in order to ensure a proper air composition. According to the exemplary embodiment, waste air from the treatment chamber 6 can be circulated or mixed with fresh air depending on the ambient conditions. The air can also be conditioned so that consistent conditions can be ensured. For example, it may not be necessary to additionally cool the outside air during germination in cold geographic regions. Conversely, in the winter in cold geographic regions, the cooling coil can also be run with warm/hot water in order to warm the fresh air 1 outside air to arrive at the desired temperature of 15-20° C. Preferably, a temperature and/or moisture sensor is installed in the plant in order to be able to monitor the air parameters. This sensor can be installed in the air channel 3 and/or in the air building 2 and/or in the heating building 1 and/or in the treatment chamber 6 above and/or below the kiln floor. It can also be advantageous to monitor the conditions in the treatment chamber 6 using an additional sensor. Sensors which are in direct contact with the product 61 can also be provided.

An exemplary air volume flow during germinating is preferably 600 m³/h per ton of cereal. The air volume flow increases virtually linearly as a function of the amount of cereal. During the kiln-drying, the air volume flow is preferably increased to approximately 3500 m/h per ton of cereal. Here, the required volume flow can also be calculated virtually linearly with the aid of the product amount. The temperatures during germination and kiln-drying can be very different depending on the desired product. The temperature during germinating is in particular 15-20° C., during kiln-drying in particular 80-120° C.

To be able to ensure a uniform germination and drying, the grain or malt is turned by means of a turning device 54. This can be embodied as a helical turning device 54, for example, and can be moved through the entire treatment chamber 6, in particular the entire length thereof, in a guided manner using guide rails mounted on the side walls of the modules. A suitable turning device is described by patent application EP 19 16 4503.5, filed on Mar. 22, 2019 by Bithler GmbH.

The grain can also be moistened during the germinating process. Furthermore, in the final module 53, an unloading station, for example in the form of a hatch 55, can be arranged which allows the finished product 61 to be removed and processed further.

If the size of the malting plant is to be altered, for example due to increased demand, one or more intermediate modules 52 can be added or removed, provided that the heating capacity of the heating device 11 permits this, that is, can provide sufficient heat for the size of the treatment chamber.

Furthermore, additional process modules 5 can be connected to a heating building 1 so that multiple batches can be processed simultaneously. In this case, care merely needs to be taken that the size of the additional process modules 5 does not exceed the heating capacity of the heating device 11.

The process modules 5 thus preferably each comprise, as a basic configuration, one air building 2 with fan 21, one base module 51, and one final module 53. Depending on the requirements. the process modules 5 can furthermore comprise one or more intermediate modules 52, and/or a heat exchanger 22.

If a heating building 1 is provided, one process module 5 is connected to the heating building 1, whereas possible additional process modules 5 are connected to the heating building via one or more connector channels 4 and return channels 41. In this example, a heat exchanger 22 is only arranged in the air building 2 connected to the heating building 1.

If two heating buildings 1 are provided, two process modules 5 are each connected to one of the heating buildings 1 and have one heat exchanger each. If additional process modules 5 are provided in the plant, these modules are connected to the heating buildings 1 via one or more connector channels 4 and return channels 41. Preferably, also for the heating building 1 connected to one another by a connector channel 4.

The plant can thus be constructed with any desired number of heating buildings 1 and process modules 5, and can be expanded or contracted in accordance with the requirements.

FIG. 2 illustrates the operation of an exemplary embodiment in germinating mode. Identical or like elements are provided with the same reference numerals as in FIG. 1. In a steep tank, which can also be part of the malting plant, grain is steeped and thus prepared for the subsequent processing. Grain that has been prepared in the steep tank is conveyed to the malting plant. For example, the grain can be conveyed together with the steeping water, through pipes connected to the malting plant, into a base module 51 and/or a final module 53, and/or, if present, into one or more intermediate modules 52, that is, into the treatment chamber 6 for germinating and kiln-drying. Multiple modules 51, 52, 53 (treatment chambers 6) can be filled consecutively. In the subsequent germinating operation, air is conducted into the region of the treatment chamber 6 located below the kiln floor 62 by the fan 21 as described above. The air can penetrate the product 61 from below through the kiln floor 62. Once it has passed through the product, the waste air is guided to the fan 21 through the air channel 3, where it is recirculated and/or temperature-controlled, and/or mixed with fresh air. Depending on the conditions of the outside air, the temperature control can thereby comprise cooling by means of the cooling system 23 or heating of the germination air by changing the function of the cooling coil of the cooling system to a hot water coil, or heating by means of the heating device 11. Furthermore, the waste air can also be discharged and only fresh air introduced into the treatment chamber 6.

FIG. 3 illustrates the air circulation of an exemplary embodiment during kiln-drying operation. Identical or like elements are provided with the same reference numerals as in FIGS. 1 and 2. For this purpose, air heated by the heating devices 11 is conducted into the region of the treatment chamber 6 located below the kiln floor 62 by means of the fan 21 and can penetrate the product 61 through the kiln floor 62. The waste air is then fed to the heat exchanger 22. There, heat recovery or heat preservation, for example, can be carried out with a supply of fresh air. The air is then heated in the heating device 11 and conducted into the treatment chamber 6 again by the fan 21. Preferably, the air channel 3 is closed and/or is not used during kiln-drying operation.

Once the kiln-drying process is completed, the product 61 can be removed from the treatment chamber 6 manually or in an automated manner via the hatch 55.

An example in which the capacity of the malting plant is fully utilized is described below. In this example, it is assumed that batches of 24 t are produced with a germination duration of 5 days, plus one day for kiln-drying. Depending on the desired product 61 and the geographic region, the germination duration may differ. It is furthermore assumed that each module has a capacity of 8 t. In order to be able to produce the batches of 24 t that are desired by way of example in a continuous manner and at full capacity, the exemplary malting plant must have six process modules 5, each of which is composed of one air building 2, one base module 51, one intermediate module 52, and one final module 53. Additionally, the plant must have a heating building 1 with a heating device 11 that is adequately sized for 24 t of product. It is also possible to use two heating buildings 1 which together provide a sufficient heating capacity for 24 t of product. Each of the six air buildings 2 must furthermore be connected to the central heating building 1 or the two heating buildings 1. On a rotating basis during production, one of the process modules 5 is in kiln-drying mode and obtains heat from the heating building 1, while the remaining five process modules 5 are in germinating mode, each staggered by one day, and are thus in recirculation or cooling mode. The process module 5 in which grain was kiln-dried is, after being emptied, filled with new grain for germination, and the process module 5 in which the grain germinated for 5 days is switched into kiln-drying mode. In this way. it is possible to run production in a continuous and space-optimized manner.

FIG. 4 shows a schematic top view of a malting plant according to an exemplary embodiment of the invention. Identical or like elements are provided with the same reference numerals as in the previous figures. With regard to the functional features, reference is made the description above. According to this embodiment, the malting plant has a heating building 1 that is connected to an air building 2. A base module 51, a final module 53, and four intermediate modules 52, which together form the treatment chamber 6, are connected to this first air building 2. The air building 2 is connected to the base module 51 via an air channel 3.

The malting plant additionally comprises one other air building 2 with one base module 51, one intermediate module 52, and one final module 53 each. Here, the air building 2 and base module 51 are also connected by means of an air channel 3. However, because the second air building 2 does not have its own heating device 11, hot air from the heating building 1 can be transported into the second air building 2 via a connector channel 4. A heat recirculation can be carried out between the first and second air buildings 2 via a return channel 41. Thus, two treatment chambers 6 can be supplied with heat using one heating device 1. As described above, the malting plant shown is embodied to be modular and purposefully expandable.

The plant can also be connected to a roasting system 8 or comprise a roasting system 8. For this purpose, one or more transport devices 81 can be provided which transport the finished product, that is, green malt in particular (i.e., germinated product that has not yet been kiln-dried) for the production of caramel malts or kiln-dried malt (finished kiln-dried product, i.e., after kiln-drying) for producing roasted malts, into the roasting system 8 for further processing. The transport devices 81 can, as shown, be provided on the final modules 53; according to an embodiment that will be described further on below, the transport devices 81 are provided on the base or starting modules 51. Thus, via the unloading station 55, the product can be removed from the treatment or process chamber and transported further into the roasting system 8.

FIG. 5 is an exemplary embodiment for the purpose of illustrating the expansion possibilities of the present invention. Identical or like elements are provided with the same reference numerals as in the previous figures. As described above, the plant can be modularly expanded or contracted. In this example, each module can hold up to 8 t of product. The malting plant shown in FIG. 5 has two heating buildings 1 and five process modules 5. Each of the process modules 5 has one air building 2 with a fan 21, though only the air buildings 2 directly connected to the heating buildings 1 additionally have heat exchangers 22. The remaining three air buildings 2 are connected to the heating buildings 1 via the connector channel 4 and can introduce the heat into the treatment chamber 6 via the respective fan 21. A heat recirculation can be achieved via the return channel 41, which also connects all air buildings 2 with one another.

Each of the air buildings 2 is connected to the related base module 51 via an air channel 3. The process module 5 on the left has only the minimum configuration, which is composed of an air building 2, base module 51, and final module 53, and therefore has a holding capacity of 16 t of product. The air building 2 does not have a heat exchanger 22. The process module 5 located adjacently thereto has an intermediate module 52 in addition to the minimum configuration, which results in a batch size of 24 t. Both of the process modules 5 equipped with a heating building 1 each have a capacity of 48 t (four intermediate modules 52). The last process module 5 on the right has a size of 24 t.

Since the heating devices 11 are each configured for a maximum capacity of 32 t in the present example, both of the large process modules 5 cannot be supplied sufficiently with heat if only one heating device 11 is used. Therefore, according to the present invention, the heating buildings 1 can be interconnected via the connector channel 4 and sufficient heat can be provided by operating only one or both of the heating devices 11, depending on which process module 5 is being run in kiln-drying mode.

The examples described illustrate the versatility of the present invention. In addition, the configurations shown in FIGS. 4 and 5 can, as described above, be expanded or contracted while taking the heating capacity into consideration. The heating technology thus can be shared, as a result of which maintenance and purchasing costs can be reduced. In return, the fan provided in each process module can be used both for heating and for cooling. The provision of one air channel per process module ensures the independence of the individual process modules. The heat exchanger provided for each heating device (burner) can increase the efficiency of the plant. Depending on the climate and ambient temperature, that is, the location of the plant, outside air can be used, admixed with the circulating air, or temperature-controlled.

The heating building 1 or heating buildings 1 can also be provided separately from the air building 2. In this case, the air building(s) 2 would be connected to the heating building(s) 1 by means of connector channels 4. Furthermore, the heat exchanger 22 can also be provided such that it is detached from the air building 2 and/or heating building 1. If the heating building 1 is detached from the air building 2, that is, is not connected, but rather installed separately, a central heating coil (hot water or steam) and/or a central gas burner can be provided for all process modules.

It can be advantageous that only one central fan is provided in the heating building 1, which fan distributes the hot air for kiln-drying into the air building(s) 2 or treatment chambers 6. If multiple heating buildings 1 are used, one fan can be installed per heating building 1. Additionally, fans which circulate the germination air can then be provided for each module group.

The present disclosure also comprises a corresponding method for malting grain, as well as a method for expanding a malting plant.

In particular, a malting plant as described above is preferably used for the method. The method comprises the germinating of the grain in the process module and the kiln-drying of the grain by heating the air by means of the at least one heating device that is arranged in the at least one heating building and is connected to each of the at least one process modules.

If a malting plant comprises at least two process modules, during the kiln-drying of grain in one of the at least two process modules, the germination of grain can be carried out in the other process module or the others of the at least two process modules.

The method for expanding of a malting plant as described above comprises the expansion of an existing process module by extending the process module, in particular through the addition of one or more intermediate modules and/or by providing an additional process module and connecting the additional process module to the heating building.

The following aspects describe embodiments of the present invention.
1. A malting plant for germinating and kiln-drying grain, having
at least one heating building (1) in which a heating device (11) can be installed, at least one process module (5) composed of
   an air building (2) with a fan (21),
   a base module (51),
   a final module (53),
wherein the air building (2) and the base module (51) are connected, and wherein the base module (51) and the final module (53) are connected and form a treatment chamber (6) for germinating and kiln-drying grain,
wherein the air building (2) is connected to the heating building (1), and
wherein the fan (21) is configured to selectively
   conduct air from outside of the air building (2) into the treatment chamber (6) and/or circulate air from the treatment chamber (6) in the treatment chamber (6) during the germinating process of the grain, and
   conduct air that has been temperature-controlled by the heating device (11) into the treatment chamber (6) during the kiln-drying process of the grain.
2. The malting plant according to aspect 1, wherein at least one intermediate module (52) can be inserted between the base module (51) and final module (53),
wherein the base module (51), the final module (53), and the at least one intermediate module (52) are connected to one another and form the treatment chamber (6).
3. The malting plant according to one of aspects 1 or 2, wherein an air channel (3) mounted externally on the process module (5) connects the base module (51) and the air building (2) and is configured to conduct waste air from the treatment chamber (6) to the fan (21) and/or to introduce hot air from the heating device.
4. The malting plant according to one of the preceding aspects, wherein a heat exchanger (22) and/or a cooling system (23) for temperature-controlling the ambient air can be installed in the air building (2).
5. The malting plant according to one of the preceding aspects, wherein one of the air buildings (2) is directly connected to the at least one heating building (1), and each of the other air buildings (2) is connected to another heating building (1) or is connected to the heating building (1) by means of a connector channel (4) between the air building (2) and heating building (1).
6. The malting plant according to one of the preceding aspects, wherein a capacity level of germinated and kiln-dried grain of the malting plant having a heating device (11) is adjustable from 16 t/batch and day to 56 t/batch and day using the number of process modules (5), and/or
wherein the capacity level (t/day) of germinated and kiln-dried grain per process module (5) spans 16 t to 56 t, preferably 16 t, 24 t, 32 t, 40 t, 48 t, and/or 56 t, and/or
wherein the malting plant comprises up to 7 process modules (5) per heating building (1).
7. The malting plant according to one of the preceding aspects, wherein each process module (5) comprises a turning device (54) and/or
comprises an unloading station (55), wherein the unloading station (55) is preferably arranged in the final module (53).
8. The malting plant according to one of the preceding aspects, wherein the at least one process module (5) is constructed rectangularly and modularly by means of modules (51, 52, 53) and is expandable.
9. The malting plant according to one of the preceding aspects, wherein the modules (51, 52, 53) have a width and a length, wherein the width of the modules (51, 52, 53) essentially corresponds to the width of the air building (2) and the length of the process module (5) depends on the number of modules (51, 52, 53).
10. The malting plant according to one of the preceding aspects, wherein the grain is arranged in the at least one process chamber (6) on an air-permeable kiln floor (62) which divides the treatment chamber (6) into a lower section and an upper section, wherein the fan (21) is configured to introduce the air through the lower section, to allow the air to flow through the grain, and to allow the air to return to the fan (21) through the upper section.
11. The malting plant according to one of the preceding aspects, furthermore having a steep tank (7) for steeping the grain, wherein the steep tank (7) is connected to the at least one process module (5) for transporting the steeped grain into the base module (51) and/or an intermediate module (52) and/or the final module (53),
wherein the steep tank (7) is preferably embodied to be modularly enlargeable.
12. The malting plant according to one of the preceding aspects, wherein the at least one heating building (1) has a fan for circulating the air that is temperature-controlled in the heating device (11).
13. A method for malting grain, in particular using a malting plant according to one of the
preceding aspects, having the following steps:
germinating the grain in the process module (5), and
kiln-drying the grain by heating the air by means of the at least one heating device (11) that is arranged in the at least one heating building (1) and is connected to each of the at least one process modules (5).
14. The method according to aspect 13, involving the use of at least two process modules (5), wherein during the kiln-drying of grain in one of the at least two process modules (5), the germination of grain is carried out in the other process module (5) or the others of the at least two process modules (5).
15. A method for expanding a malting plant according to one of aspects 1 through 12 through the expansion of an existing process module (5) by extending the process module (5), in particular through the addition of one or more intermediate modules (52) and/or by providing an additional process module (5) and connecting the additional process module (5) to the heating building (1).

Additional, preferred embodiments of the present invention will now be described below with reference to FIGS. 6 through 8.

A malting plant according to the preferred embodiment is shown in FIG. 6 and comprises a steeping unit 7, a germinating/kiln-drying unit 5, and a heating unit 1 in which a heating device 11 is installed. Both the number of germinating/kiln-drying units 5 and also the number of intermediate modules 52 in the germinating/kiln-drying units 5 taken individually can be provided in multiple realizations.

Both the steeping unit 7 and also the germinating/kiln-drying unit 5 can be adapted to the requirements of the respective plant and, accordingly, comprise a starting module 51 with a germinating fan 21, an end module 53, and therebetween a process chamber 6 with at least two intermediate modules 52. The process chamber 6 is a standardized Saladin box (see for example Bergner, K. G. et al.: Alkoholische Genussmittel [Alcoholic Beverages], Springer Berlin Heidelberg, 2013 (Handbuch der Lebensmittelchemie [Handbook of Food Chemistry]). A Saladin box refers to a stationary kiln floor on which the product lies and on which air flows through the product.

The germinating/kiln-drying unit 5 is formed by a starting module 51, at least two intermediate modules 52, and an end module 53, and can, if necessary, be expanded through the insertion of additional intermediate modules 52 by moving the end module 53. When the germinating/kiln-drying unit 5 is expanded, the end module 53 is detached from the existing intermediate module 52 to which it is connected. Here, the screws of the U-profiles connected to one another are unscrewed, and the end module is moved. As part of this, an inspection shaft for the waste water, which shaft is arranged under the germinating/kiln-drying unit 5, can also be moved, and the sewage pipe can be extended by the length of the intermediate module. Likewise, a pump line from the already-existing intermediate module is extended into the new intermediate module to feed product. The energy chain for the turning device 54 is also extended by the length of the intermediate module. The starting module 51, at least two intermediate modules 52, and the end module 53 are connected to one another. The intermediate modules 52 thereby provide in the interiors thereof a process chamber 6 in which the germinating and kiln-drying of the grain can be carried out. The starting module 51 is furthermore connected to the heating unit 1.

Preferably, each starting module 51, intermediate module 52, and end module 53, hereinafter also referred to as “modules,” has the same dimensions. The modules are preferably embodied to be rectangular. In addition, they can be formed from rust-proof stainless steel or sheet metal parts or steel beams. Each end module 53 is thereby closed on three sides during operation, and can be connected to other modules via the open side. Preferably, a movable process-chamber end wall 91 is installed on the open side in the starting module, which wall can be moved back in the direction of the starting module 51 in order to open an integrated unloading device 55 below. The starting module 51 is connected to the heating unit 1 on one side and on the ceiling via air channels 4, 41, and is open on the opposite side and can therefore be connected to intermediate modules 52. The open side of the starting module 51 is connected to the end module 53 via at least two intermediate modules 52. Each of the intermediate modules 52 is thus open on two sides so that it can be arranged between the starting module 51 and end module 53.

Preferably, the modules have a height of approximately 5 m, a width of approximately 4.2 m, and a length of approximately 4.5 m. Maximally, 7 intermediate modules with a length of 4.5 m each can be used, which corresponds to a total length of 7×4.5 m=31.5 m (starting module, 7 intermediate modules, and end module). In particular, each of the modules preferably holds a capacity of 4 to 10 t, particularly preferably 8 t. Specific densities of cereal are 45-54 kg/hl for oats, 57-70 kg/hl for barley, 58-77 kg/hi for rye, and 62-87 kg/hl for wheat. Other dimensions of the modules may also be expedient.

In the heating unit 1, at least one heat exchanger 22 and and a gas burner and/or heating coil for steam or hot water can be used. A cooling system (not shown) or a cooling coil are installed in the starting module in the integrated air channel. ICS COOL ENERGY, iC530/iC660 can be used as cooling technology for the germination air, for example (https://www.iescoolenergy.com/app/uploads/Broschuere_I-Chiller_ICSCoolEnergy_2018.pdf). In addition, the malting plant or the starting module 51 comprises an integrated air channel 3 in which a germinating fan 21 is situated and which is connected to the process chamber 5. Normally, the cooling system is situated outside of the process module 5, and the cooling coil is situated in the air channel 3 on a discharge side (pressure side) of the germinating fan 21, for example. The air channel 3 is preferably integrated inside of the starting module. It is particularly preferred if the air channel 3 is situated next to an electric control box chamber in the starting module.

As a heating device 11 in the heating unit 1, a burner, a hot water coil, or a boiler can be used, for example. In addition, other heat sources, such as geothermal energy, heat pumps, or solar systems for example, can be used. An additional plate heat exchanger can utilize the waste heat of neighboring industrial operations to increase the efficiency, for example. This heat exchanger can be situated in the heating unit 1 or in connector channels. If at least one cross-flow heat exchanger 22 is used, the waste air is mainly used during the wilting process in kiln-drying, in order to heat the fresh air in the cross-flow method.

In the process chamber 6, formed by at least two intermediate modules 52, the malt is germinated, and is subsequently dried or kiln-dried. Normally, an air-permeable kiln floor 62 is installed there, which kiln floor 62 divides the treatment chamber 6 into an upper and a lower region. The product 61 is preferably arranged in the upper region, and air is introduced into the lower region and can penetrate into the product 61 through the kiln floor 62. In the process, the air can be temperature-controlled depending on the requirements. Preferably, the air channel 3 connects the starting module 51 to the intermediate module 52. The upper region of the process chamber 6 of the starting module 51 is thereby connected and the germinating fan 21 in the air channel 3 via the air channel 3, which fan 21 transports the air into the lower region of the process chamber 6. In other words, the waste air that has already passed through the product 61 is conducted out of the upper region of the process chamber 6 and recirculated into the lower region of the process chamber 6 via the germinating fan 21. Depending on the mode of operation (germinating or kiln-drying), the waste air can be conducted through the air channel 3 (germinating) or to the kiln-drying fan 24 via the at least one heat exchanger 22 (or heating device 11 in the heating unit 1) and the heating device 11. For this purpose, devices, in particular cut-off dampers, can be used which prevent the supply and discharge to the starting module 51 from the direction of the heat exchanger 22 or heating unit 1 during germination on the one hand and, on the other hand, stop the ingress into the air channel 3, or stop the ingress of air from the air channel 3 into the process chamber via the starting module 51, during kiln-drying.

The air can thereby be circulated by the kiln-drying and germinating fan(s) either in an unmodified manner or such that it is temperature-controlled by means of the cooling system 23 or the heating device 11 in the heating unit 1. In addition, a heat exchanger 22 can be arranged in the heating unit in order to increase the efficiency. This heat exchanger 22 can be embodied in particular as a cross-flow heat exchanger. The germinating process can thus take place independently for each germinating/kiln-drying unit 5 via the integrated air channel in the starting module. The kiln-drying process, in turn, is supplied with temperature-controlled air via the heating unit 1. In addition, the central kiln-drying fan 24, the hating device 11, and optionally also at least one (cross-flow) heat exchanger 22 are also located in the heating unit 1.

In the starting module 51, both in the air channel 3 for germinating and also in the fresh air channel 4 and return air channel 41 for kiln-drying, means (not shown) are preferably provided for selectively conveying the air from the air channel 3 (circulation or cooling operation) or from the heating unit 1 or the heating device 11 (heating operation) or from the ambient environment (outside air) into the treatment chamber 6. In particular, these means can be embodied as louvers or dampers. These can, in particular, be integrated in the heating unit 1, in locations in which the channels, in particular the return air channel 41, are also arranged. Other devices may also be expedient. The air channel 3 can furthermore comprise a return air damper. a fresh air damper, and positive pressure louver or the like in order to ensure a proper air composition. According to the exemplary embodiment, waste air from the treatment chamber 6 can be circulated or mixed with fresh air depending on the ambient conditions. The air can also be conditioned so that consistent conditions can be ensured. For example, it may not be necessary to additionally cool the outside air during germination in cold geographic regions. Conversely, in the winter in cold geographic regions, the cooling coil can also be run with warm/hot water in order to warm the fresh air/outside air to the desired temperature of 15-20° C. Preferably, a temperature and/or moisture sensor is installed in the plant in order to be able to monitor the air parameters. This sensor can be installed in the air channel 3 and/or in the fresh air channel 4 and return air channel and/or in the heating unit 1 and/or in the process chamber 6 above and/or below the kiln floor. It can also be advantageous to monitor the conditions in the process chamber 6 using an additional sensor. Sensors which are in direct contact with the product 61 can also be provided.

An exemplary air volume flow during germinating is preferably 600 m³/h per ton of cereal. The air volume flow increases virtually linearly as a function of the amount of cereal. During the kiln-drying, the air volume flow is preferably increased to approximately 3000 m³/h per ton of cereal. Here, the required volume flow can also be calculated virtually linearly with the aid of the product amount. The temperatures during germination and kiln-drying can be very different depending on the desired product. The temperature during germinating is in particular 15-20° C., during kiln-drying in particular 80-120° C.

To ensure a uniform germination and drying, the grain or malt is turned by means of a turning device 54. This can be embodied as a helical turning device 54, for example, and can be moved through the entire process chamber 6, in particular the entire length thereof, in a guided manner using guide rails mounted on the side walls of the intermediate modules 52. A suitable turning device is described by patent application EP 19 16 4503.5, filed on Mar. 22, 2019 by Bühler GmbH. The grain can also be moistened during the germinating process. Furthermore, in the starting module 51, an unloading station 55, for example in the form of an integrated unloading device below the movable process-chamber end wall 91, can be arranged which allows the finished product 61 (green malt after germinating or kiln-dried malt after kiln-drying) to be removed and processed further.

If the batch size of the malting plant is to be altered, for example in a stepwise manner due to increased demand, one or more intermediate modules 52 can be added or removed, provided that the heating capacity of the heating device 11 permits this, that is, can provide sufficient heat for the size of the treatment chamber.

Furthermore, additional germinating/kiln-drying units 5 can be connected to a heating unit 1 so that multiple batches can be processed simultaneously. In this case, care merely needs to be taken that the batch size of the additional germinating/kiln-drying units 5 does not exceed the heating capacity of the heating device 11.

The germinating/kiln-drying units 5 thus preferably each comprise, as a basic configuration, one starting module 51, at least one intermediate module 52, and one end module 53. Depending on the requirements, the germinating/kiln-drying units 5 can furthermore comprise two, three, or more intermediate modules 52.

If a heating unit 1 is provided, one germinating/kiln-drying unit 5 is connected to the heating unit 1, whereas possible additional germinating/kiln-drying units 5 are connected to the heating unit 1 via one or more fresh air channels 4 and return air channels 41. In this example, a heat exchanger 22 is only arranged in the starting module 51 connected to the heating unit 1.

One germinating/kiln-drying unit 5 is connected to the heating unit 1 via fresh air channels 4 and return air channels 41. If additional germinating/kiln-drying units 5 are provided in the plant, these units are connected to the heating unit 1 via the one or more fresh air channels 4 and return air channels 41.

The plant can thus be expanded or contracted up to seven germinating/kiln-drying units 5 (24 h batch cycle) using one heating unit 1.

In a steep tank or steeping unit, which can also be part of the malting plant, grain is steeped and thus prepared for the subsequent processing. Grain that has been prepared by the steeping unit is conveyed to one or more germinating/kiln-drying units 5. For example, the grain can be conveyed together with the steeping water, through pipes connected to one or more germinating/kiln-drying units 5, into the one or more intermediate modules 52, that is, into the process chamber 6 for germinating and kiln-drying. Multiple intermediate modules 52 (process chambers 6) can be filled consecutively. In the subsequent germinating operation, air is conducted into the region of the process chamber 6 located below the kiln floor 62 by the germinating fan 21. The air can penetrate the product 61 from below through the kiln floor 62.

Once it has passed through the product, the waste air is guided to the germinating fan 21 in the air channel 3 of the starting module 21, where it is recirculated and/or temperature-controlled and/or mixed with fresh air. Depending on the conditions of the outside air, the temperature control can thereby comprise cooling by means of the cooling system 23 or heating of the germination air (in very cold winter periods or low outside temperatures) by changing the function of the cooling coil of the cooling system to a hot water coil. Furthermore, the waste air can also be discharged and only fresh air introduced into the process chamber 6.

During kiln-drying operation, air heated by the heating devices 11 from the heating unit 1, as illustrated in FIG. 7, is conducted into the region of the process chamber 6 located below the kiln floor 62 through the fresh air channel 4 by means of the kiln-drying fan 24 and can penetrate the product 61 through the kiln floor 62. The waste air is then fed to the at least one heat exchanger 22 through the return air channel 41. There, heat recovery or heat preservation, for example, can be carried out with a supply of fresh air. The air is then heated in the heating device 11 in the heating unit 1 and conducted into the process chamber 6 again by the kiln-drying fan 24. Preferably, the air channel 3 is closed by the starting module and/or is not used by the starting module during kiln-drying operation. In the heating unit 1, a control room, that is an electric control box chamber, is provided for controlling the heating unit.

Once the kiln-drying process is completed, the product 61 can be removed from the process chamber 6 manually or in an automated manner via the integrated unloading station in the starting module 51.

FIG. 8 schematically shows a top view of a malting plant according to an embodiment of the invention. A heating unit 1, as shown for example in FIG. 7, is connected to two germinating/kiln-drying units 5 via a fresh air channel 4. The air flow from the heating unit 1 into the germinating/kiln-drying units 5 is supplied by the kiln-drying fan 24 during the kiln-drying process. After flowing through the process chambers in the germinating/kiln-drying units 5, the air is guided back into the heating unit 1 via the return channel 41.

An example in which the capacity of the malting plant is fully utilized is also described below for the preferred embodiment. In this example, it is once again assumed that batches of 24 t are produced with a germination duration of 5 days, plus one day for kiln-drying. Depending on the desired product 61 and the geographic region, the germination duration may differ. It is furthermore assumed that each module has a capacity of 8 t. In order to be able to produce the batches of 24 t that are desired by way of example in a continuous manner and at full capacity, the exemplary malting plant must have six germinating/kiln-drying modules 5, each of which is composed of one starting module 51, at least three intermediate modules 52, and one end module 53. Additionally, the plant must have a heating unit 1 with a heating device 11 and a central kiln-drying fan 24, which device is adequately sized for 24 t of product. Each of the six starting modules 51 must furthermore be connected to both the steeping unit 7 and also to the heating unit 1. On a rotating basis during production, one of the germinating/kiln-drying units 5 is in kiln-drying mode and obtains heat from the heating device 11 of the heating unit 1, while the remaining five germinating/kiln-drying units 5 are in germinating mode, each staggered by one day, and are thus in recirculation or cooling mode. The germinating/kiln-drying unit 5 in which grain was kiln-dried is, after being emptied, filled with new grain arriving from the steeping unit 7 for germination, and the germinating/kiln-drying unit 5 in which the grain germinated for 5 days is switched into kiln-drying mode. In this way, it is possible to run production in a continuous and space-optimized manner.

FIG. 4, which was already described above, can thus also be understood as a schematic top view of a malting plant according to the preferred embodiment of the invention. In the following description of the preferred embodiment, the terms are used accordingly for the reference numerals stated. With regard to the functional features, reference is made the description above.

According to the preferred embodiment, the malting plant has a heating unit 1 that is connected to two starting modules 51 of two germinating/kiln-drying units 5. In addition to a starting module 51 and an end module 53, one of the germinating/kiln-drying units 5 has two intermediate modules 52. In addition to a starting module 51 and an end module 53, the second germinating/kiln-drying unit has four intermediate modules 52. Both germinating/kiln-drying units 5 are connected to both the steeping unit 7 and also to the heating unit 1.

A heat recirculation can be carried out from the germinating/kiln-drying units 5 back to the heating unit 1 via a return air channel 41. Thus, two treatment chambers 6 can be supplied with heat using one heating device 11 in a heating unit 1. As described above, the malting plant shown is embodied to be modular and expandable.

In FIG. 5, which was likewise already described above, a further exemplary embodiment is shown for the purpose of illustrating the expansion possibilities of the present invention, which can also be depicted with reference to the preferred embodiment as follows. Identical or like elements are once again provided with the same reference numerals as in the previous figures.

As described above, the plant can be modularly expanded or contracted. In this example, each module can once again hold up to 8 t of product. The malting plant shown in FIG. 5 has a heating unit 1 and five germinating/kiln-drying units. Each of the germinating/kiln-drying units has a starting module 51, possibly intermediate modules 52, and an end module 53. The germinating/kiln-drying units are connected to the heating unit 1 via the fresh air channel 4 and can introduce the heat into the process chamber in one of the five germinating/kiln-drying units via the central kiln-drying fan 24. A heat recirculation can be achieved via the return air channel 41, which is also connected to all germinating/kiln-drying units.

Each germinating/kiln-drying unit has an integrated air channel in the staring module 51. The germinating/kiln-drying unit on the left has only a starting module 51 and an end module 53, and has a holding capacity of 16 t of product. The germinating/kiln-drying unit located adjacent thereto additionally has an intermediate module 52, which results in a batch size of 24 t. The germinating/kiln-drying units adjacent thereto each have a capacity of 48 t (four intermediate modules 52). One germinating/kiln-drying unit with the maximum capacity of 56 t could have seven intermediate modules 52 (not shown). The last germinating/kiln-drying unit 5 on the right has a size of 24 t (one intermediate module 52). If, as is provided according to the preferred embodiment described above, the process chamber is formed solely by the intermediate modules, the above example can be adapted accordingly. In this case, the minimum configuration comprises one intermediate module with a starting module and an end module; the standard configuration has two intermediate modules and can be expanded up to a size of seven intermediate modules.

Since the heating devices 11 are each configured for a maximum capacity of 56 t in the above example, if the heating device 11 is used all other (smaller) germinating/kiln-drying units 5 can also be supplied sufficiently with heat from one heating unit 1 using this heating device 11. Therefore, according to the present invention, all germinating/kiln-drying units 5, regardless of the capacity, can be supplied the heating unit 1 via the fresh air channel 4, with sufficient heat by operating only one or both of the heating devices 11 of the heating unit, depending on which of the germinating/kiln-drying units 5 is being run in kiln-drying mode.

The examples described illustrate the versatility of the present invention. In addition, the configurations shown in FIGS. 4 and 5 can, as described above, be expanded or contracted while taking the heating capacity into consideration. The central kiln-drying fan can distribute the heated air from the heating unit into the germinating/kiln-drying unit via the connector channels.

The provision of one air channel 3 with a germinating fan 21 per germinating/kiln-drying unit 5 ensures the independence of the individual germinating/kiln-drying units. The heat exchanger 22 provided in the heating unit can increase the efficiency of the plant. Depending on the climate and ambient temperature, that is, the location of the plant, outside air can be used, admixed with the circulating air, or temperature-controlled.

FIG. 9 shows a schematic view of a malting plant as described above. This plant additionally has a steep tank or steeping unit 7 that can be provided as part of the malting plant or can be provided externally. A fresh water reservoir can be situated below the steeping unit 7. In respect of the functional principle of the steep tank 7, see above. An exemplary embodiment of a steep tank 7 is described below with reference to FIG. 10. The steeped grain can be wet-pumped into the treatment or process chamber 6, that is, one of the modules 51, 52, 53, or—in the case of the preferred embodiment—one of the intermediate modules 52, via a pump line 71. In the case of a dry transport from the steep tank to the treatment chambers, conveyor belts, trough chain conveyors, screw conveyors, tube chain conveyors, or elevators can be used. It can also be expedient to steep the grain directly in the treatment or process chamber 6. For this purpose, a washing screw in particular can be provided before the grain enters the process module or the germinating/kiln-drying unit 5.

FIG. 10 shows a schematic view of an expandable steep tank or steeping unit 7 that can be combined with the malting plant described. For this purpose, a cylindroconical steep tank 7 is described by way of example. FIG. 10(a) shows the basic configuration of the steep tank 7 for the smallest batch size. The cylindroconical steep tank 7 has a lid 72 on which a product feed 73 for filling the grain and a device for fresh air supply 74 can be provided. Furthermore, in the device for the fresh air supply 74, a cooling coil for temperature-controlling the supply air can be provided. In the interior of the cylindroconical steep tank 7, a fully automatic skimming device 75 is preferably provided. This device preferably also has a safety overflow. In particular, floating barley, dust, and other floating, non-germinable pieces are removed via the skimming device 75. After the steeping process, the steeped grain is gravimetrically steeped out via the opening on the cone floor and transported for further processing.

If the malting plant is enlarged as described above, it may be necessary to adapt the capacity of the steep tank 7 accordingly. For this purpose, one or more intermediate rings 76 can be installed in order to increase the volume, and thus the product capacity, of the cylindroconical steep tank 7. FIG. 10(b) shows a configuration of the steep tank 7 from FIG. 10(a) with an additional intermediate ring 76. To mount this ring. the lid 72 with the attached product feed 73 and fresh air supply 74 is first removed. One or more intermediate rings 76 are subsequently positioned on the cylindroconical steep tank 7. FIG. 10(c) is an illustration with two mounted intermediate rings 76. The intermediate rings 76 can be connected to the cylindroconical steep tank 7, or to the other intermediate ring 76, by means of a screw connection and a seal, for example. The connections between the steeping cylinder and the intermediate rings or the lid can alternatively be welded. Furthermore, the height or length of the skimming device 75 can be adapted accordingly. This can be accomplished, for example, by replacing the funnel and the pipe sections. An additional steep tank can also be provided.

The steeping unit 7 can thus have in particular a conical base section, a cylindrical lid 72, and a ring-shaped intermediate section. The capacity of the steeping unit 7 can be increased or reduced in a stepwise manner by inserting or removing intermediate rings 76 in the intermediate section. To ensure adequate stability of the steeping unit 7, the steeping unit 7 has in cross section, in particular in the region of the intermediate rings 76, preferably an essentially circular inner wall and a hexagonal outer wall, as shown in the cross-sectional view in FIG. 10(d).

All of the plants described can, as shown in FIG. 4, also be combined with roasting systems.

In place of a burner, a boiler plant can also be used as a heating device 11. This plant can be operated with water or steam. The plant can be run with gas, oil, wood pellets or wood chips, or with other heating systems, in order to thus temperature-control water to such an extent that this hot water or steam can supply the steam coil or water coil. In this case, a steam coil is mounted on the suction side of the kiln-drying fan 24 in the heating unit 1. A heat-exchange coil that functions according to the counterflow principle, for example. can also be provided.

In addition, the heat exchanger 22 or cross-flow heat exchanger can be replaced by a heat pump. This requires, even for operation with a burner, coils on the suction side of the kiln-drying fan 24 in the heating unit 1. The water or steam coils are preferably installed on the suction side of the central kiln-drying fan 24 in the heating unit 1. The heat pump is preferably only used for the kiln-drying mode. The efficiency and energy efficiency can thus be increased. This results in the ability to use a heating device 11, burner, or boiler plant with smaller dimensions. Furthermore, the heat pump can be supplied with electricity from a photovoltaic system.

The present disclosure also comprises a corresponding method for malting grain, as well as a method for expanding a malting plant.

In particular, a malting plant as described above is preferably used for the method. The method comprises the steeping of the grain in a steeping unit, the germinating of the grain individually in a germinating/kiln-drying unit 5 independent of other germinating/kiln-drying units 5. And the kiln-drying of the grain by heating the air by means of a heating device 11 that is arranged in heating unit 1 and is connected to each of the at least one germinating/kiln-drying units 5.

The method can be carried out with the use of at least one steeping unit 7, one germinating/kiln-drying unit 5, and one heating unit 1, wherein the steeping unit 1 can be implemented independently of the germinating/kiln-drying unit 5. in the combined germinating/kiln-drying unit, either the germinating or the kiln-drying process can be carried out.

The method for expanding a malting plant as described above comprises the stepwise expansion of the batch capacity by extending the germinating/kiln-drying unit 5, in particular through the addition of one or more intermediate modules 52 and/or by providing one or more additional germinating/kiln-drying units 5 and connecting the additional germinating/kiln-drying unit(s) 5 to the heating unit 1.

The expansion method according to the invention is schematically illustrated in FIG. 11. In a germinating/kiln-drying unit of an existing malting plant, as illustrated for example in FIG. 6, the modules are first separated. In the embodiment shown, the intermediate module 52 present is separated from the end module 53, while the intermediate module remains connected to the starting module 51. The end module 51 is only implied in FIG. 11, but it corresponds to the end module 53 from FIG. 6, that is, it in particular also has the corresponding channels, the fan, and the unloading station. Of course, to expand the malting plant, the intermediate module can also remain on the end module, but can be separated from the starting module. The removed module is removed from the remaining modules, and an additional intermediate module 52′ is arranged between the detached (end) module and the intermediate module 52 that was already present beforehand. The walls, ceilings, and floors of the modules are preferably formed by U-profiles. These can therefore be connected, and preferably screwed, to the newly inserted U-profiles, which have the same dimensions, that is, to the additional intermediate modules 52. Through the insertion of additional intermediate modules 52, the process chamber 6 of the malting plant 1 can be expanded in a stepwise manner.

In EP 2 336 458 Bi, a method for producing a container for germinating or kiln-drying malt from multiple wall elements is described. The method and devices shown therein are described in relation to round containers, but can also be used accordingly for germinating/kiln-drying units according to the present invention. The subject matter of EP 2 336 458 B1 is therefore incorporated in its entirety by way of reference.

Although the invention has been depicted and described in detail by means of the drawings and the accompanying specification, said depiction and said detailed description are to be understood as being illustrative and exemplary, and non-limiting for the invention. Of course, persons skilled in the art can make amendments and modifications without departing from the scope of the claims below. In particular, the invention also comprises embodiments with any combination of features that have been stated or shown above for various aspects and/or embodiments.

The invention likewise comprises individual features in the drawings, even if they are shown therein in connection with other features and/or are not stated above.

Furthermore, the expression “comprise” and derivations thereof do not exclude other elements or steps. Likewise, the indefinite article “a” or “an” and derivations thereof do not exclude a plurality. The purposes of multiple features recited in the claims can be satisfied by one entity. The terms “essentially”, “approximately”, “about” and the like in combination with a property or a value also in particular define precisely that property or precisely that value, respectively. All reference numerals in the claims are to be understood as non-limiting for the scope of the claims.

### LIST OF REFERENCE NUMERALS

1 Heating building or heating unit
11 Heating device
2 Air building
21 (Germinating) fan
22 Heat exchanger
23 Cooling system
24 (Kiln-drying) fan
3 Air channel
4 Connector channel or fresh air channel
41 Return channel or return air channel
5 Process module or germinating/kiln-drying unit
51 Base module or starting module
52 Intermediate module
53 Final module or end module
54 Turning device
55 Unloading hatch or unloading station
6 Treatment or process chamber
61 Product
62 Kiln floor
7 Steep tank or steeping unit
71 Pump line
72 Lid
73 Product feed
74 Fresh air supply
75 Skimming device
76 Intermediate ring
8 Roasting system
81 Transport device
91 Movable process-chamber end wall

1. An expandable malting plant for germinating and kiln-drying grain, having a heating unit in which a heating device can be installed and at least one expandable germinating/kiln-drying unit, with
a starting module having an air channel with a germinating fan, wherein the starting module is connected to a connector channel and a return channel to the heating unit,
at least one intermediate module, and
an end module,
wherein the starting module connected to the intermediate module, and wherein the intermediate module is connected to the end module end to form a process chamber for germinating and kiln-drying grain,
wherein the capacity level of the malting plant can be adjusted by changing the size of the process chamber,
wherein the malting plant is configured to selectively
conduct air from outside of the starting module into the process chamber and/or circulate air from the process chamber via the air channel into the process chamber using the germinating fan during the germinating process, and
conduct air that has been temperature-controlled by the heating device in the heating unit via the connector channel into the process chamber via the starting module during the kiln-drying process of the grain.

2. The malting plant according to claim 1, wherein at least one additional intermediate module can be inserted between the starting module and the end module,
so that the starting module, the at least two intermediate modules, and the end module are connected to one another and the intermediate modules form the process chamber, wherein the capacity level of the malting plant can be adjusted by inserting the at least one intermediate module.

3. The malting plant according to claim 1, wherein return air and/or fresh air can be conducted into the process chamber in the air shaft by the germinating fan.

4. The malting plant according to claim 1, wherein the heating unit has at least one heat exchanger, the heating device, and a central kiln-drying fan for temperature-controlling the fresh air and/or recirculating air.

5. The malting plant according to claim 4, wherein the kiln-drying fan is configured to conduct air that has been temperature-controlled by the heating device through the connector channel into the process chamber via the starting module during the kiln-drying process of the grain, and to return the air to the heating unit again via the return air channel, either via the heat exchanger or directly to the heating device.

6. The malting plant according to claim 1, wherein a capacity level of germinated and kiln-dried grain of the malting plant having a heating device is adjustable from 16 t/batch and day to 56 t/batch and day using the number of germinating/kiln-drying modules, and/or
wherein the capacity level of germinated and kiln-dried grain per germinating/kiln-drying unit spans 16 t to 56 t, preferably 16 t, 24 t, 32 t, 40 t, 48 t, and/or 56 t, and/or
wherein the malting plant comprises up to 7 process modules per heating unit.

7. The malting plant according to claim 1, wherein each germinating/kiln-drying unit comprises a turning device and/or
comprises an unloading station, wherein the unloading station is preferably arranged in the starting module.

8. The malting plant according to claim 1, wherein the at least one germinating/kiln-drying unit is rectangular, and wherein by inserting intermediate modules the batch capacity can be expanded in a stepwise manner in accordance with the number of intermediate modules inserted.

9. The malting plant according to claim 1, wherein the modules have a width and a length, and the length of the germinating/kiln-drying units is dependent on the number of intermediate modules.

10. The malting plant according to claim 1, wherein the grain is arranged in the at least one intermediate module on an air-permeable kiln floor which divides the process chamber into a lower section and an upper section, wherein the germinating fan in the air channel is configured to introduce the air through the lower section, to allow the air to flow through the grain, and to allow the air to return to the air channel through the upper section.

11. The malting plant according to claim 1, furthermore having a steeping unit for steeping the grain, wherein the steeping unit is connected to the at least one germinating/kiln-drying unit for transporting the steeped grain into the process chamber, wherein the steeping unit preferably has a cylindroconical shape, having in cross section an essentially circular inner wall and hexagonal outer wall.

12. The malting plant according to claim 11, wherein the steeping unit has a conical base section, a cylindrical lid, and a ring-shaped intermediate section, wherein the capacity of the steeping unit can be increased in a stepwise manner by inserting intermediate rings in the intermediate section.

13. A method for malting grain using a malting plant according to claim 1, comprising:
germinating the grain in the germinating/kiln-drying unit, and
kiln-drying the grain by heating the air by the at least one heating device that is arranged in the heating unit and is connected to each of the at least one germinating/kiln-drying units.

14. The method according to claim 13, involving the use of at least two germinating/kiln-drying units, wherein during the kiln-drying of grain in one of the at least two germinating/kiln-drying units, the germination of grain is carried out in the other germinating/kiln-drying unit or the others of the at least two germinating/kiln-drying units.

15. A method for expanding a malting plant according to claim 1, through a stepwise increase in batch size by inserting intermediate modules in the germinating/kiln-drying unit and/or by providing an additional germinating/kiln-drying unit and connecting the additional germinating/kiln-drying unit(s) to the heating unit and/or by expanding the capacity of the steeping unit.
